(19) United States
(12) Patent Application Publication
(10) Pub. No.: US 2004/0060808 A1
(43) Pub. Date: Apr. 1, 2004

(54) Advective solar collector for use in multi-effect fluid distillation and power co-generation

(76) Inventor: Paul Alex LaViolette, Alexandria, VA (US)

Correspondence Address: Paul A. LaViolette, 6369 Beryl Road, # 104, Alexandria, VA, 22312, US

(21) Appl. No.: 10/633,437

(22) Filed: Aug. 4, 2003

Related U.S. Application Data
(63) Continuation-in-part of application No. 09/924,134, filed on Aug. 8, 2001, now abandoned.
(60) Provisional application No. 60/224,002, filed on Aug. 9, 2000.

(51) Int. Cl. B01D 3/42; F28B 1/00

(52) U.S. Cl. 202/234; 202/160; 202/189; 203/1; 203/49; 203/2; 203/DIG. 1; 159/44; 159/903; 159/16.1

(57) ABSTRACT

A solar still apparatus is described for the multi-effect distillation of a fluid such as water. A transparent condenser air duct overlies an evaporator air duct having a light-absorbing floor, both sharing a transparent plastic film wall. Air, blown by a fan, flows through the lower duct, where it progressively warms and evaporates a feedstock fluid. At the hot end of the lower duct, the air enters the upper duct where it flows in a reverse direction, progressively cooling and condensing its vapor, a portion of the heat of condensation being transferred through the shared wall to the lower duct. Thermal gradients established within the still facilitate the evaporation and condensation of the fluid with minimal heat loss to the environment and maximal recuperation of the heat of condensation for fluid evaporation. A working fluid may be used to extract useful power from the still's thermal gradients.

### REFERENCES CITED

U.S. Patent Documents

| | | | |
|---|---|---|---|
| 3,317,406 | May 1967 | Beard | 203/10 |
| 3,334,026 | August 1967 | Dobell | 203/10 |
| 3,908,631 | September 1975 | Rom | 126/270 |
| 4,363,703 | December 1982 | ElDifrawi | 203/10 |
| 4,458.673 | July 1984 | Benjamin | 126/443 |
| 4,344,824 | August 1982 | Soleau | |

Other References

G. Mink et al. “Design parameters, performance testing and analysis of a double-glazed, air-blown solar still with thermal energy recycle.” Solar Energy, vol. 64, Nos. 4-6, pp. 265-277, 1998.

UK Patent GB 2,214,835 A, September 1989, S. Gahin.

### CROSS REFERENCE TO RELATED APPLICATIONS

This application is a continuation-in-part of U.S. application Ser. No. 09/924,134 filed on Aug. 8, 2001 for an invention that claims priority to provisional disclosure application number 60/224,002 filed on Aug. 9, 2000.

### BACKGROUND OF THE INVENTION

The Advective Solar Collector (ASC) described in this invention relates to the field of water purification in that it can be applied to distill water into fresh water. It also applies more generally to the technology of distilling fluids other than water such as alcohol or benzene. This still uses solar energy to evaporate feedstock fluid into a ducted airstream and subsequently condenses the vapor of this fluid from the airstream to produce a purified fluid that is free of dissolved salts and insoluble residues. Considering the example of water distillation, this apparatus may be used in areas where sunlight is available to distill, seawater, brackish well water, or contaminated river water for domestic or industrial consumption. In the application to agriculture, the ASC still may be used to desalinate agricultural drainage water for reuse in irrigation. It may also be used to distill high-salinity water produced from oil and gas wells and effluents from chemical processing plants, paper mills, and sewage treatment plants prior to discharge to the environment.

The ASC solar still may also supplement its solar energy input with the additional input of waste heat derived from an external source such as a power plant or air conditioning system, or it may use such waste heat as an alternate heat source during times when solar energy is unavailable, as during night time hours. Use of power plant waste heat for water cogeneration has the additional benefit that cool water would be returned to the power plant for cooling purposes, thereby eliminating the need for a powerplant cooling tower. As is discussed further on, the ASC solar still may also be combined with a turbine generator to produce electrical or mechanical power as a by-product.

Early solar still designs were of the greenhouse variety. As illustrated in FIG. 1, the prior art greenhouse solar still absorbs solar radiation by means of a horizontal light-absorbing panel which in turn heats an overlying layer of water. The heated water evaporates, the vapor condenses on a cool, inclined window pane that forms the roof of the still, and the condensed droplets run down this pane to collect in a trough. All of the solar energy that is absorbed to evaporate water is discharged to the environment through the roof of the still in order to allow the vapor to condense. Greenhouse solar stills are of the single-effect type which means that they use the incident solar radiation only once to distill a given amount of feedstock water. Stills that recycle the heat of condensation to assist the water evaporation process are instead termed multi-effect stills.

Greenhouse stills in tropical regions generally have a distillation efficiency of around 30%, and are capable of producing about 0.07 gal/ft²/day, or about 3 liters (l) per m² per day in tropical latitudes. In December 2002, the Intermediate Technology Development Group of the Schumacher Center for Technology & Development estimated that greenhouse solar still installations cost $95/m². This implies a water cost of about $25 per 1000 gallons. By comparison, due to its multi-effect design, the ASC is able to achieve a much higher production rate. It would distill water at seven times the rate of a greenhouse solar still and at less than one-fourth of the cost. It is able to produce distilled water at a cost sufficiently low as to make it competitive with alternative methods of distillation such as reverse osmosis membrane technologies.

### BRIEF SUMMARY OF THE INVENTION

A key distinguishing feature of the ASC solar still invention is that it is able to establish a temperature gradient along its length within an air space that is thermally insulated from the environment and is able to use this gradient for conducting multi-effect water distillation. In addition, this thermal gradient may be used for the purpose of generating power. Like a conventional flat plate solar collector, the ASC solar still has a solar radiation absorber as its lower surface, preferably black in color, and one or more light-transmitting films or sheets for its upper surface; see FIG. 2, FIG. 3 and FIG. 4. As in the greenhouse still, feedstock water covers the floor of the still to a depth of about a half an inch to a few inches. But in addition, the still includes a partition that extends horizontally along its length, situated midway between its lower solar absorber surface and its light-transmitting roof so as to divide its interior air space into lower and upper air ducts. The partition is both light-transmitting and sufficiently thin so as to allow heat to transfer at an appreciable rate from the upper condenser air duct to the lower evaporator air duct. As one example, this partition may be formed of a transparent plastic film having a thickness in the range of 0.5 to 10 mils.

The still also contains a fan that forces air to circulate along the length of its air ducts. The fan, which is positioned within one of the air ducts preferably at one end of the lower evaporator air duct, blows air down the length of the duct. The advected air is heated and humidified through contact with the layer of solar heated water and is also heated through contact with the warm light-transmitting partition above it. This air progressively heats up and becomes saturated with an increasing quantity of water vapor as it passes down the length of the still.

Upon reaching the hotter end of the still, the air passes from the lower air duct through a hole, or opening, in the light-transmitting partition and enters the upper condenser air duct. There, it reverses its flow to proceed back toward the cooler, opposite end of the still. As it proceeds, it progressively cools, losing heat upward through the light-transmitting roof of the still and downward through the film partition. As this air cools, fresh water condenses onto the walls of the upper duct and this condensate gathers at the edges of the air duct and flows toward the cool end of the still where it is pumped out. Upon reaching the cool end of the still, the air passes through another hole, or opening, in the light transmitting partition to reenter the lower evaporator air duct, and thus circulates in a closed loop.

Just as there is a time lag in heating as the air flows through the lower evaporator air duct, so too there is a time lag in cooling as the air flows through the upper condenser air duct. The air in the upper air duct does not begin to cool immediately since the upper surface of this air duct is insulated from the outside air by one or more light-transmitting films or sheets. Consequently, the temperature gradients in the upper condenser and lower evaporator air ducts will be shifted with respect to one another so that the air in the upper condenser air duct will be warmer than the air in the lower evaporator air duct directly below it, as illustrated in FIG. 5. The resulting temperature differential causes heat to conduct and radiate through the plastic film partition from the upper to the lower airstreams. Consequently, a large fraction of the heat of condensation released from the upper airstream is transferred to the lower airstream where it assists the water evaporation process. Thus the ASC operates as a multi-effect solar still. The lower airstream is heated both by contact with the light-transmitting partition above it and solar heated water surface below it, while the upper airstream is cooled both by contact with the underlying light-transmitting partition and with the still's overlying light-transmitting roof.

By having long air ducts, the ASC still is able to form a large temperature differential within the still from its cool end to its hot end. That is, the length of the air ducts is sufficient to give the blown air time to effect a substantial change of temperature as it absorbs heat in the lower evaporator air duct or discharges heat in the upper condenser air duct. Since air is able to hold an increasing amount of vapor with increasing temperature, a greater temperature differential along the length of the still will allow a given volume of advected air to evaporate and condense a greater quantity of vapor. This lengthwise temperature differential may be maximized by fabricating the walls of the air ducts from thermally insulating materials such as plastic film (or EPDM membrane for the floor of the still) so that heat from the hot end of the still is not easily conducted along the lengths of these walls to the cool end of the still. By ensuring that the partition between the evaporator and condenser ducts is sufficiently thin, heat from the condenser air duct will be able to flow into the evaporator air duct at a sufficiently high rate to allow recuperation of the heat of condensation. By also ensuring that this partition is light-transmitting, solar radiation may easily pass downward through the still, penetrating through the condenser air duct to the floor of the still where it assists water evaporation.

Since heat escapes from a solar collector most readily through its upper, sun-facing surface, it is preferable to have the condenser air duct uppermost in the still so that any upward heat loss will aid condensation. This upward heat loss is instrumental in creating the thermal gradient along the length of the air duct as air is advected through it. Also, by placing its condenser air duct above its evaporator air duct, the ASC design minimizes upward heat loss from its evaporator air duct. For example, partition 10 dividing the two air ducts prevents vertical air convection currents from transferring heat from the lower evaporator air duct to the roof of the still. Also since water and humidified air acts as an infrared absorber, the warm, humidified air and condensate present in the overlying air duct will impede radiant heat from escaping upward and leaving the evaporator. The ASC design, minimizes heat loss through the floor of the evaporator duct by ensuring that its evaporator air duct is lowermost in the still and that the floor of this air duct and its underlying insulating layer rests on the ground. Any heat escaping through the insulating layer will pass into the ground where it becomes stored for night time use, rather than being lost to the air environment.

These design features together reduce the rate of heat loss from the ASC still which in turn boosts the temperature in its interior at both the warm and cool ends of the still. Since air's ability to hold water vapor increases exponentially with increasing temperature, it is beneficial for the overall temperature of the still's thermal gradient to be as high as possible so as to maximize the vapor-to-air ratio and therefore to maximize the rate of water distillation. Similar reasoning applies to the distillation of other fluid vapors.

The ASC still will establish its greatest temperature differential between its hot and cool ends at an optimal advection velocity, i.e., at an optimal fan speed. This speed depends upon variables such as the cross sectional area of the air duct, the heat capacity of the advected air medium, the rate of solar energy input from the still's light-absorbing floor, and the rate of heat loss to the environment. If the fan speed is too low, the air will attain its upper temperature limit before reaching the end of the lower air duct. If the fan speed is too high, the air arriving at the high-temperature end of the still will not yet have reached its potentially highest temperature.

Higher fan speeds will transport air and vapor at a greater rate through the still but will also tend to reduce the magnitude of the still's lengthwise thermal gradient which, in turn, will reduce the amount of water vapor extracted from each unit volume of air. So, increasing fan speed too far will result in a decreased rate of water distillation. Since incident solar radiation and ambient air temperature change with time of day and season, an optimal thermal gradient along the length of the still could be maintained by varying the fan speed accordingly. One type of control circuit that might do this would use a timer to change the fan speed for various times of the day or night and would incorporate additional seasonal settings to tailor the speed to the time of the year. If multiple fans are used to advect air down the length of the air duct, the control circuit might instead regulate the number of fans that are in operation at any one time. Alternatively, fan speed might be regulated according to sunlight intensity. That is, lower sunlight intensities, hence lower rates of heat input to the still, would require proportionately lower fan speeds to maintain an optimal thermal gradient. Due to the large heat capacity of the water covering the floor of the still, the maximum still temperature would be reached after noon peak solar intensity. Hence, if a photoelectric cell control circuit is employed to regulate fan speed, it is best to orient this photoelectric cell or photosensitive device to have maximum insolation in the early afternoon. A third type of control circuit might regulate the fan speed by sensing the thermal gradient of the lower airstream at the hot end of the still, using thermistors spaced apart by 10 percent of the length of the still. If the fan speed became too slow, then the lower airstream would reach its upper temperature limit before reaching the end of the evaporator passage. The thermistors would sense the resulting low temperature difference and would increase the fan speed until a preset temperature difference was achieved.

As illustrated in FIG. 5, at any given location along the length of the still, the air temperature in the upper air duct will tend to be higher than that in the lower air duct. Anything that increases this temperature differential will increase the rate of heat transfer from the upper to lower air duct and hence will increase the distillation efficiency of the still. One way of increasing this temperature differential is to design the still so that the cross-sectional area of its upper air condenser duct is constricted near its warmer end and expanded near its cooler end. This causes air to move more rapidly down the length of the upper condenser air duct at the duct's warmer end and to move more slowly down the length of this air duct at the duct's cooler end. As a result, air in the upper condenser air duct will drop in temperature more slowly as it advects down the length of the duct at the warmer end of the still and will develop a greater temperature differential in relation to the air in the lower air duct immediately below it.

In summary, the ASC solar still differs from prior art solar stills in that it:

a) establishes thermal gradients along its length that facilitate both the evaporation and subsequent condensation of its water or fluid,

b) recycles a large fraction of its heat of condensation along most of the length of its condenser section to facilitate its evaporation process, and

c) places a light-transmitting condenser section over its evaporator section to retard heat loss from the evaporator and to take advantage of the normal heat flow through its roof to have this heat be lost preferentially from its condenser section.

As a result of these features, the ASC still is able to achieve a higher maximum temperature in its evaporator air duct and a higher maximum temperature differential between the warm end of its evaporator air duct and the cool end of its condenser air duct with a consequent higher rate of distillation.

In addition to distilled water, the ASC still may produce shaft power or electric power as a by-product for use in operating its fan or for electric utility power generation. A condenser coil is placed in the lower air duct at the cool end of the still and an evaporator coil is placed in the upper air duct at the hot end of the still, both coils containing a working fluid. The working fluid pressure differential developed between the two coils may be used to drive a turbine or heat engine connected to an electrical generator for producing electrical power. Alternately, other means could be employed to extract heat from the warm end of the still for use in power generation. By amortizing the ASC still with respect to two by-products (power and distilled water) instead of one (distilled water), its economics become more competitive. The ASC still may also be designed so that it uses an external source of waste heat to supplement solar energy as its input heat source or to serve as an alternate heat source. For example, it may use cooling water waste heat discharged from the heat exchanger of either a nuclear, fossil fuel, or geothermal power plant. Or, it may also use waste generated by an air conditioner heat pump. The ASC still may also use waste heat from an external source of solar heated water, such as, for example, heat captured in a hot brine solar pond. During daylight hours, heat from such external sources would supplement solar heating of the feedstock water, while during night time hours, the still's feedstock water would be heated solely by this external hot water source. This has the benefit of allowing the still to operate continuously day and night thereby increasing its production efficiency.

Taking as an example the use of power plant waste heat, hot cooling water exiting from the heat exchangers of a power plant would be piped to an array of adjacent ASC solar still bays and made to flow through heat exchange pipes lying on the floor of each bay and directed along the bay's length. This water would flow through these pipes from the hot end of the still to its cool end, giving up its heat to the feedstock water that covers the floor of the still and surrounds the heat exchange pipes. These heat exchange pipes would ensure that the power plant cooling water does not mix with the still's saline feedstock water. This cooling water would exit the still at its cool end and be piped back to the power plant heat exchangers at a lower temperature. Since the cooling water would flow in a closed loop, the ASC solar still would serve as a cooling loop for the power plant (or air conditioner), thereby taking over the function normally carried out by a wet or dry cooling tower. Such co-generation is particularly advantageous in arid areas where water is scarce. By recycling its cooling water through the ASC still, such an arrangement would conserve water that would otherwise be evaporated as cooling water in a cooling tower. Furthermore by using its waste heat to distill brackish ground water, a power plant combined with an ASC still would function as a net producer of fresh water, rather than as a net water consumer.

In some situations where the external hot water source is itself brackish and in need of distillation, there would be no need to separate the external source of hot water from the pool of brackish feedstock water being evaporated in the still. Examples would include water from a geothermal well or saline water produced from oil and gas wells, which often can reach temperatures as high as 160° F. In such cases, no heat exchange pipes would be needed. The external source of hot water would be made to enter at the hot end of the still and allowed to mix with the pool of feedstock water. Cool feedstock water would then drain from the cool end of the still at a lower rate. A drain pipe having its entrance one or two inches above the floor of the still would automatically regulate the height of the water in the still.

The ASC still may also be designed so that it circulates air through its air ducts in an open loop mode. In this case, the fan blows outside air into the lower evaporation air duct at the cool end of the still, the air passes to the warm end of the still, enters the upper condenser air duct, and returns to the cool end of the still where it exhausts to the atmosphere, instead of reentering the lower air duct. Although this open loop configuration would share many of the advantages of the closed loop design, such as multi-effect distillation, it would have the disadvantage that by exhausting warm humid air to the environment it would lose heat. With this heat no longer available to help evaporate water in the lower air duct, both the hot and cool ends of the lower air duct would shift to lower equilibrium temperatures. Since the saturation vapor pressure of air increases nonlinearly with temperature, this will result in substantially less water being distilled for the same amount of circulated air. An open loop design would be assisted if used in conjunction with the wet cooling tower of a power plant, the humidified exhaust air from the cooling tower being used as preheated air inputted to the lower air duct of the ASC still. Also, heat from the outgoing air could be partially recycled by passing the air through a heat exchanger to preheat the incoming feedstock water.

Several other solar stills have used forced air advection to enhance their evaporation and condensation processes. These include the prior art inventions of Beard (U.S. Pat. No. 3,317,406) and Dobell (U.S. Pat. No. 3,334,026) and the non-prior art still of ElDifrawi et al. (U.S. Pat. No. 4,363,703) in which air is blown over solar heated water and the vapor is subsequently distilled by passing the humidified airstream through a condenser. However, unlike the ASC still, these forced air circulation stills have their solar heated evaporator section physically separated from their condenser section. Except for a small portion which is recovered to heat the feedstock water that enters the evaporator, most of the heat of condensation released in their condenser is not returned to the evaporator but is instead lost to the environment. As an example, one gram of feedstock water preheated in the condenser section might absorb about 40 to 60 calories of heat to be recycled to the evaporator, as compared with 540 calories of heat that are released in the condenser as a result of condensing one gram of water from the advected airstream. Since only about 10% of the heat of condensation is recycled, these feedstock preheater designs essentially function as single-effect stills.

In the solar stills of Beard and ElDifrawi et al., the evaporator and condenser air ducts are not juxtaposed and do not share a thermally conductive wall along their length, nor are thermal gradients established along the length of the air ducts to assist heat flow from the evaporator to the condenser. One version of the Dobell design does have evaporator and condenser air ducts that are juxtaposed and sharing a common wall, but this wall is not made of a thin film or of thermally conductive material that would allow heat to transfer at an appreciable rate from the condenser airstream to the evaporator airstream. The condenser chamber air duct is described as a vertical pipe positioned within, and concentric with, a vertical cylindrical evaporator chamber, the ducts being so arranged to take advantage of the chimney effect to assist the upward transport of warm air in the outer, evaporator air duct and the downward transport of cool air in the inner condenser chimney. As mentioned above, these three stills function essentially as single-effect stills.

The non-prior art solar stills of Soleau (1982) and Gahin (1988) also use forced air advection to assist water evaporation, but differ from the advective stills of Beard, Dobell, and ElDifrawi in that both evaporator and condenser are located within the same enclosure. However, they too function essentially as single-effect stills since they use their heat of condensation only to preheat the inlet water entering their evaporators, this amounting to only a fraction of the total available heat of condensation. The non-prior art solar still of Gahin (1988) positions its evaporator and condenser air ducts adjacent to one another. However, unlike the ASC still, the partitioning wall which these air ducts share in common is only a structural feature and is not intended for heat transfer purposes. That is, it is not described as being thermally conductive or for the purpose of allowing heat to move from the condenser to the evaporator air duct. Hence this still does not operate as a multi-effect still. Neither is its condenser air duct positioned between its evaporator air duct and the transparent wall that admits solar energy.

At the time the ASC still was first conceived in 1975, no other prior art solar stills had used the idea of air advection within a single enclosure for the purpose of producing multi-effect distillation. Since that time an air advection, multi-effect solar still was developed by Mink et al. (1998). This non prior art solar still is similar to the ASC still to the extent that it also advects humidified air through an evaporator air duct and then into an adjacent condenser air duct in thermal contact with the evaporator air duct. However, the two stills differ in that the ASC still positions its condenser air duct above its evaporator air duct, instead of below this duct. Also the Mink et al. still partitions its evaporator and condenser air ducts by means of an opaque metal sheet rather than by a thin transparent film. Furthermore, this still circulates its air in an open loop whereas, the ASC still, in its normal configuration, circulates its air in a closed loop.

The design features of the ASC still have several advantages over those of the still of Mink et al. First, by placing its condenser air duct above its evaporator air duct, the ASC design minimizes upward heat loss from its evaporator air duct. The still of Mink et al., on the other hand, relies solely on the insulating effect of its double glazed transparent cover to impede heat flow from its evaporator to the environment. As a result, the ASC still is able to achieve feedstock water temperatures in its evaporator air duct higher than those achievable in the evaporator air duct of the Mink still and also higher than those normally achieved in a greenhouse still.

As mentioned earlier, the considerable length of the ASC still air ducts allows them to establish a large temperature differential between their opposite ends when air is passed through them. A substantial air path length is necessary in order to allow sufficient time for the blown air to effect a substantial change of temperature by either absorbing or discharging heat. The air flow path in the still of Mink et al., however, is rather short, being only about 2 meters in length. Also that still uses a sheet of copper as a thermal exchange partition between its evaporator and condenser, with this partition being in direct contact with its pool of feedstock water. The short length of the Mink et al. still and its use of a relatively high thermal conductivity surface in its wall structure both serve to reduce the magnitude of the temperature gradient that the still is able to establish along the length of its air ducts. For example, measurements show that at its optimal air flow rate the Mink et al. solar still develops a temperature differential of only about 3 to 4° C. over 80% of its air duct length. By comparison, a 10 meter long ASC still would be able to achieve a temperature differential of at least 10° C. between its cool end and hot end. This temperature differential would increase as the length of the still is increased, reaching 30° to 40° C. for a 30 meter long still. With its large temperature differential, the ASC still is able to take advantage of the heating and cooling time lag of its advected air to develop a substantial temperature differential (e.g. 3° C.) between the evaporator air stream and its adjacent condenser air stream over most of the length of the still. By comparison, in the still of Mink et al. there is essentially no temperature differential between the evaporator and condenser air ducts over 80 percent of their contact length. Heat transfer in that still occurs primarily over about 20 percent of the air duct length where cool outside air enters the evaporator duct depressing its air duct temperature about 5° C. relative to that of the condenser air duct below it. Consequently, the ASC design more effectively recuperates its heat of condensation for use in feedstock water evaporation.

The idea of a solar still that incorporates air inflated plastic film ducts as its entire structure, or as a major portion of its structure, is a novel aspect of one construction of this invention. This has the advantage of allowing the still to be made portable for use in remote locations where a temporary supply of water is needed during a period of drought or other emergency. That is, the still may be rolled up into a compact bundle for storage or transport and later unrolled and inflated when needed to be put into operation. F. Rom has patented an inflatable single-pass solar air heater in 1975 (U.S. Pat. No. 3,908,631). According to this design, a fan was made to blow air down a long plastic film tube which had a light-transmitting upper layer and a black solar absorbing lower layer. During its passage down the length of the tube, the air was heated by contact with the hot floor of the tube and would exit at the far end of the tube where it would provide a source of hot dry air for some application such as for ventilating a grain elevator. This design also made use of a second light-transmitting film overlying the first and inflated above it so as to provide extra thermal insulation for retaining heat within the solar collector. G. Benjamin also patented a single-pass, inflatable solar air heater in 1984 (U.S. Pat. No. 4,458,673) (non-prior art). According to this variation, air is blown through a black central plastic air duct surrounded by a second inflated tube that is transparent on its upper surface and reflective on its lower surface. However, the Rom and Benjamin solar air heaters were not designed for the purpose of water distillation. Consequently, unlike the ASC still, these designs do not humidify their airstream. Also they do not reverse the air flow at the hot end of their air ducts so as to direct the flow back toward the cool end of their ducts so as to facilitate heat exchange between juxtaposed air ducts.

### BRIEF DESCRIPTION OF THE DRAWINGS

FIG. 1 is a cross sectional end view of a prior art greenhouse solar still.

FIG. 2 is a cross sectional side view of an advective solar collector still embodying the principles of the invention.

FIG. 3 is a perspective view of an end cross section of the still illustrated in FIG. 2.

FIG. 4 is a magnified end view of one edge of the advective solar collector still illustrated in FIG. 2.

FIG. 5 presents a hypothetical example illustrating how air temperature would vary along the length of the upper and lower air ducts in an advective solar collector still.

FIG. 6 is a cut away perspective view of the still showing a pleated wick covering the floor of the still.

FIG. 7 is a cross sectional side view of the still showing sprinkler humidification.

FIG. 8 is a cross sectional side view of the still showing vertical vanes for inducing air turbulence.

FIG. 9 is a magnified end view of the left edge of an advective solar collector still that has a roof formed of two light-transmitting, flexible sheets.

FIG. 10 is a cut away perspective view of the hot end of the still showing a means for charging the air stream as it enters the upper air duct.

FIG. 11 is a top view of the floor of an advective solar collector still illustrating an arrangement of heat exchange pipes for utilizing waste heat from an external source.

FIG. 12 is a view of a solar farm composed of an array of adjacent solar still bays.

FIG. 13 is a top view of the central portion of the advective solar collector still designed to have a circular floor geometry.

FIG. 14 is an edge view of the circular advective solar collector still shown in FIG. 13.

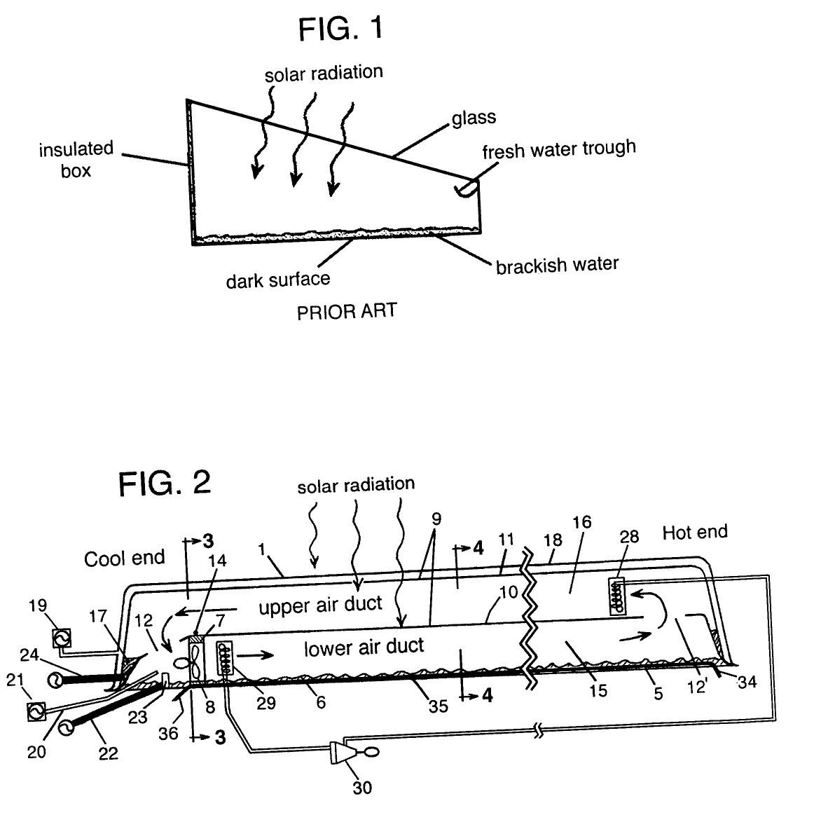

### DETAILED DESCRIPTION OF THE INVENTION

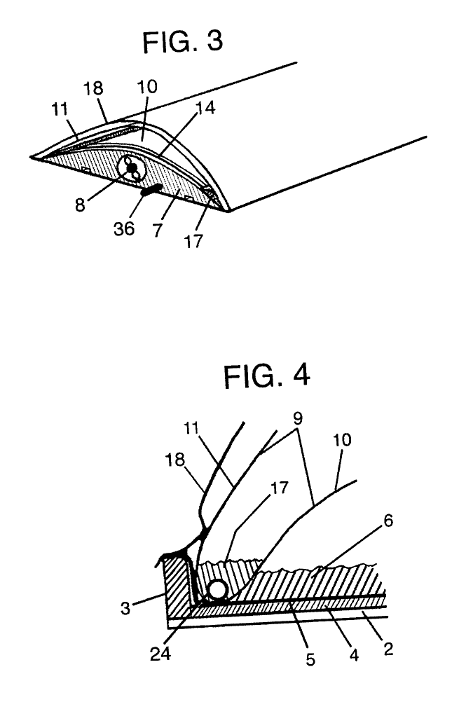

The primary embodiment of my invention is illustrated in FIG. 2, FIG. 3, and FIG. 4 which depict a practical design of a single distillation bay 1 adapted to on-site construction. The still module is tubular in shape, about ½ to 2 meters wide and 10 to 150 meters long. In one example, a bay module might measure approximately 1.1 meters wide and 20 meters long. The base of the still may be constructed by placing a series of plywood sheets 2, long-end to long-end, and nailing them to wooden beams 3, said beams being secured along the edges of the sheets so as to form an elongate basin. A sheet of insulation 4, such as high-density neoprene foam, or fiberboard, is secured to the upper surface of the plywood and is covered with a layer 5 of light-absorbing waterproof material which extends up the sides of the basin. Materials that could be used for this light-absorbing material include 45 mil thick EPDM (ethylene propylene diene ter polymer) membrane, butyl rubber sheet, dark silicone rubber membrane, or a heat sealable plastic such as black polyethylene film having a thickness in the range of 5 to 10 mils. The floor of the enclosure so formed is covered with a layer of feedstock water 6 to a depth of about half an inch to a few inches. Alternatively, a fluid other than water may serve as the feedstock fluid for distillation. In a variation of this construction, plywood sheet 2 and insulating sheet 4 may be replaced by a slab of insulating concrete, e.g., either air entrained concrete or concrete made from a mixture of cement and perlite.

An arch-shaped baffle 7, measuring approximately 5 to 10 cm thick spans the width of the basin and is secured upright at one end of the bay. In one example, this baffle may be made from polystyrene foam. A fan 8 is mounted at the center of the baffle. A tube 9 made of light-transmitting plastic film and comprised of a lower layer 10 and an upper layer 11, overlies the basin and extends horizontally along the basin's length.

The tube 9 may be composed of materials such as FEP, Tefzel®, Tedlar®, polyetheylene, polyvinylchloride (PVC), or Mylar. FEP-L Teflon® film has an expected life exceeding 20 years. Another Teflon film product called Tefzel has twice the strength of FEP, and its light transmission degrades only by about 3 percent over a 20 year time period. Tedlar®, polyetheylene, PVC, and Mylar® are not as desirable as Tefzel® or FEP since they deteriorate under long exposure to the ultraviolet component in sunlight. Use of PVC film is discouraged for drinking water applications since this plastic contains a plasticizer which could transfer into the hot distillate and contaminate the water supply.

Tube 9 has a circumference of about 3 meters, a length about equal to the length of the basin, and its walls have a thickness typically in the range of 2 to 6 mils. As one example, when the tube is viewed in cross section, its lower layer 10 will have an arc length measuring in the range of 1.20 to 1.35 times the width of the basin, while its upper layer 11 will have an arc length measuring in the range of 1.45 to 1.65 times the width of the basin. Tube 9 may be fabricated by heat sealing two elongate light-transmitting plastic films to one another at their outer edges. Each end of the tube also is heat sealed shut. Near each of these ends, the tube's lower layer 10 is breached by openings 12 and 13, each opening having a diameter measuring approximately 30% to 70% of the width of the still.

The edges of tube 9 are secured to layer 5 along the perimeter of the basin either by means of weights placed inside the tube along its edges, or by an attaching means such as strips of Velcro® or cupped film-gripping strips. The latter might consist of a cupped piece of plastic, one edge of which is fastened to the floor of the still and which would have sufficient flexibility to allow its opposing edge to be lifted sufficiently so that an edge of tube 9 and its interior condensate drain pipe could be tucked underneath the strip.

Lower layer 10 of tube 9 overlies baffle 7 and is secured or sealed to the baffle's upper edge either by means of glue, by heat sealing its surface to the baffle, by placing weights within the tube positioned directly over the edge of the baffle, or by pressure applied from a flexible hoop 14. Alternatively, the fan may instead be mounted in opening 12 so that it blows air into the lower air duct, the fan's baffle being secured at its perimeter to lower layer 10.

When in operation, the fan inflates plastic film tube 9 so that lower and upper layers 10 and 11 arch upward, as illustrated in FIG. 3. The circumference of the tube measures about 2.5 to 3 times the width of the basin, thereby allowing the tube the freedom to bow upward when inflated. The lower layer 10 constitutes a light-transmitting partition that divides the air space of the still into a lower evaporator air duct 15 and an overlying upper condenser air duct 16. The fan draws air from the upper condenser air duct 16 through first opening 12 and exhausts it down the length of the lower evaporator air duct 15. This air then passes through second opening 13 to enter the upper condenser air duct 16 where it flows down the length of that air duct in a direction opposite to its flow in the lower evaporator air duct. Upon reaching the end of the upper air condenser duct, the air flows through first opening 12 to reenter the lower evaporator air duct, thus circulating in a closed loop.

Since the floor of the still is fabricated of a dark, light-absorbing material, incoming sunlight will heat the layer of feedstock water covering it. As the fan's exhausted air passes down the length of the lower evaporator air duct, it becomes saturated by contact with the warmed water. Because water is evaporating and entering the airstream, a considerable amount of heat must be transferred to the airstream in order to raise its temperature. Due to this heating time lag, or “thermal inertia,” a temperature gradient forms along the length of the still, temperature increasing in the direction of air flow. The air reaches its highest temperature at the end of the evaporator air duct. Upon passing through second opening 13 into the upper air duct and reversing its direction to travel toward the cool end of the still, the air passes down the prevailing thermal gradient, losing heat to the tube's upper and lower film layers 10 and 11. Drops of water condense out of the airstream onto the tube's wall to collect along its lower edges to form a pool of condensate 17 which is in thermal contact with the layer of feedstock water 6, as seen in the edge detail illustrated in FIG. 4.

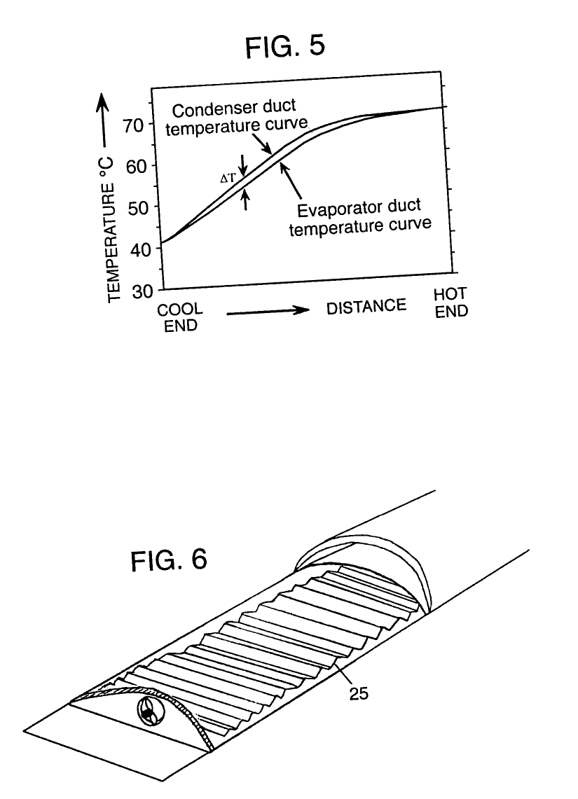

Throughout the greater portion of the still, the air in the upper condenser air duct will be warmer than the air in the lower evaporator air duct. This is due to the time lag involved in heating the air in the lower air duct and the complementary time lag involved in cooling air in the upper air duct, as illustrated in FIG. 5. As a result of this temperature inversion, heat will conduct and radiate through lower layer 10 from the upper to the lower air duct. The condensate 17 that collects at the edges of the plastic tube will generally be cooler than the upper air duct air stream, but warmer than the adjacent pool of feedstock water 6. Consequently, the upper surface of the peripheral condensate pool will serve as an additional surface upon which condensation will take place, and the heat of condensation so imparted will conduct through lower film layer 10 to warm the feedstock water.

Teflon films such as FEP, Tefzel, or PVF have the advantage that they are hydrophobic so that water condenses on their surface in droplets rather than as a smooth film. Research has shown that dropwise condensation enhances the heat transfer process. If the film partition between the lower and upper air duct s is not inherently hydrophobic, it is advisable to apply a light-transmitting hydrophobic coating to the upper surface of the tube's lower film layer 10 to encourage droplet condensation. Also a light-transmitting hydrophilic coating may be applied to the undersides of both the lower film layer 10 and upper film layer 11 to discourage droplet formation and upward heat loss there.

To insulate the upper surface of the still and impede the upward loss of heat, it is advisable to add an additional light-transmitting insulating layer 18 to cover the upper half of the tube as shown in FIG. 2, FIG. 3 and FIG. 4. This insulating layer 18 may be made from a weather resistant heat sealable plastic film such as FEP or Tefzel® Teflon® film having a thickness of about 2 to 5 mils. This may be secured or heat sealed to the upper layer 11 of tube 9 on either side of the tube nearest the basin periphery. A small external blower 19 would keep this outer film inflated with dry outside air so as to form a dead air space between the two adjacent film surfaces 11 and 18. Alternatively, the insulating layer 18 may be fabricated of a light-transmitting stiff, flexible sheet made of plastic or fiberglass that is sprung against the sides of the basin to form an arched tunnel. In one example, this flexible sheet might be composed of 40 mil Sunlite® fiberglass sheet produced by the Kalwall Corp. Alternatively, it may be formed of an 8 mm thick double walled ribbed polycarbonate sheet such as Polygal®. Such a flexible sheet would have the advantage of better protecting the still from external mechanical damage and also of being self supporting without the need for a separate external air blower. However, due to UV absorption, such sheets would deteriorate and need to be replaced more frequently than if Teflon film were used. Fiberglass sheet, for example, yellows and develops visible crazing of its outer surface after 10 years. Polycarbonate would retain its clarity for a longer period. Additional light-transmitting canopies may be added over insulating layer 18 to create additional dead air spaces for better insulation and higher operating temperatures. If plastic film is used, these added layers may be kept inflated by the same external blower 19.

To prevent a low pressure from forming in the air space directly behind the fan, the still incorporates an air vent tube 20, typically about 2 cm in diameter, communicating from behind the fan to the outside atmosphere. This ensures that a positive pressure with respect to atmospheric will be maintained throughout the still when the fan is operating and that the structure of the still will remain inflated. Hence, the fan serves two purposes: a) to advect air down the length of the lower and upper air ducts and b) to inflate these air ducts. If the fan and its baffle are mounted in the lower evaporator air duct, vent tube 20 would open into the lower air duct near the fan intake. If the fan and its baffle is instead mounted in opening 12, vent tube 20 would open into the upper condenser air duct near the fan intake. In the case where the fan is turned off during the night to conserve power, the structure may be kept inflated by an auxiliary external blower 21 attached to the air vent tube. If necessary, the floor of the still may be bridged by a series of arching struts or hoops so as to prevent the lower film layer 10 from collapsing onto the water surface during such shut-off periods.

Feedstock water is admitted into the still through a pipe 22 which discharges to the cool end of the feedstock water pool 6. A float valve 23 admits feedstock water to the still whenever the water level in the still's water pool drops too low. To prevent salt deposits from building up, the concentrated brine remaining in pool 6 is periodically removed from the cool end of the still by pumping or draining it through pipe 22. Brine removal may be scheduled for night time hours to minimize heat loss from the still. Fresh water condensate collecting in pool 17 along the edge of the upper air duct enters fresh water outlet pipe 24 that is immersed in this pool and which extends along the length of tube 9, said condensate entering said pipe through perforations along its length. This pipe would convey this condensate out of the still at its cool end.

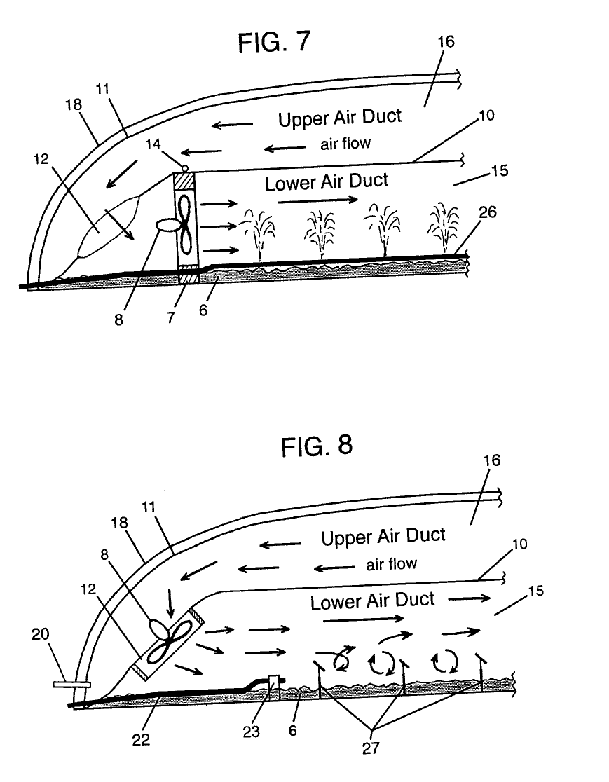

Humidification of the lower airstream may be enhanced by covering the floor of the still with a light-absorbing pleated wick 25, as shown in FIG. 6. This wick may be made of a water-absorbing fabric and arranged such that its pleats dip into the feedstock water. Thus, air blowing over the wet fabric encounters a greater surface area for evaporation. Alternatively, referring to FIG. 7, humidification may be enhanced by spraying the input feedstock water into the airstream along the length of the evaporator chamber. One way this could be done is by pumping this water through a perforated plastic sprinkler hose 26 of the sort used to sprinkle water on lawns.

The humidification and condensation processes may also be improved by increasing the amount of airstream turbulence since turbulence increases the rate of heat transfer between the airstream and surrounding surfaces, thereby assisting heat transfer from the upper to the lower air duct. As one example, if the air passage has a perimeter of 3 meters and if air is advected through it at a speed of 0.1 m/sec, the air flow will have a Reynolds number of 17,000 characteristic of turbulent flow, laminar flow becoming turbulent for Reynolds numbers above 10,000. Higher fan speeds will produce greater airstream turbulence and greater rates of heat transfer. However, excessively high fan speeds would have the disadvantage that the increased air flow resistance would place a greater power demand on the fan. Turbulence may also be increased by using two adjacent fans, rather than a single fan, to blow air through the air ducts. In addition, turbulence may be increased by placing in the lower air duct a series of elongated vanes 27 oriented crosswise so as to deflect the air flow either upward or downward, see FIG. 8.

As shown in FIG. 2, an evaporator heat exchanger coil 28 is situated in the upper air duct near the hot end of the still so that heat from the advected air will evaporate its contained working fluid liquid and assist in condensing water from the airstream. Also a condenser heat exchanger coil 29 is situated in the lower air duct near the cool end of the still downstream of the fan 8. Heat released from condensation of its contained working fluid vapor will be transferred to the advected air and assist in evaporating feedstock water. These heat exchangers are connected via pipes to a turbine or heat engine 30 so that the pressure differential of their working fluid may be harnessed to provide shaft power for generating electricity. This shaft power or electrical power may in turn be used to actuate the fan 8 or to provide surplus electrical power for a nearby utility grid.

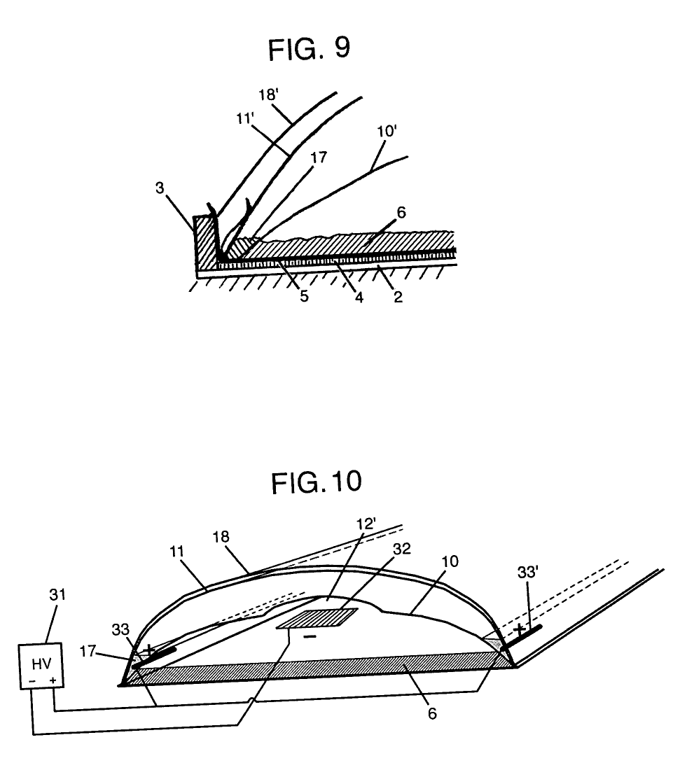

Referring to FIG. 9, in another embodiment of the still, two light-transmitting, stiff, flexible sheets 11′ and 18′ would replace the upper light-transmitting plastic film layers 11 and 18 of the condenser air duct. The edges of the flexible sheets would be sprung against the basin curb boards to form arches separated from one another by a dead air space. This would leave a single light-transmitting plastic film 10′ to serve as the partition between the evaporator and condenser air ducts. The edges of this film would be sealed to the edges of the flexible sheet on either side of the solar still bay. These arched tunnels would be capped off at either end of the bay by insulating end pieces. Plastic film 10′ would be appropriately gathered and secured at the ends of the bay so that its contained condensate does not mix with the feedstock water.

To sanitize the distillate from any microorganisms that may enter it, a high voltage direct current source 31 may be used to ionize the airstream at the hot end of the still; see FIG. 10. This source may typically have a voltage of 8000 volts or more. One electrical pole from this source (e.g., the negative) would be connected to an electrode or grid 32 which would be placed in the lower air duct air stream beneath opening 13 while the opposite electrical pole (e.g., the positive) would be connected to electrodes 33 and 33′ lying at the edges of the upper air duct to charge the pool of condensate 17 accumulating there. As an added advantage, ions dispersed from grid 32 into the air stream and entering the upper air duct will cause a greater percentage of vapor to condense on layer 10, as opposed to layer 11. These negative ions will act as nuclei for vapor condensation. The nonconductive lower and upper layers 10 and 11 will become negatively charged as these negative ions contact their surfaces and the condensate accumulating at the edges of the upper air duct will acquire a positive charge from electrodes 33 and 33′. Hence the negatively charged condensation nuclei fog droplets will tend to be electrostatically repelled from surfaces 10 and 11 and electrostatically attracted to condensate pool 17. As a result, a greater percentage of water vapor will condense at the edges of the still and a lesser amount will condense on upper layer 11 ensuring that a greater amount of heat will be recuperated by transfer through layer 10 to the layer of feedstock water 6.

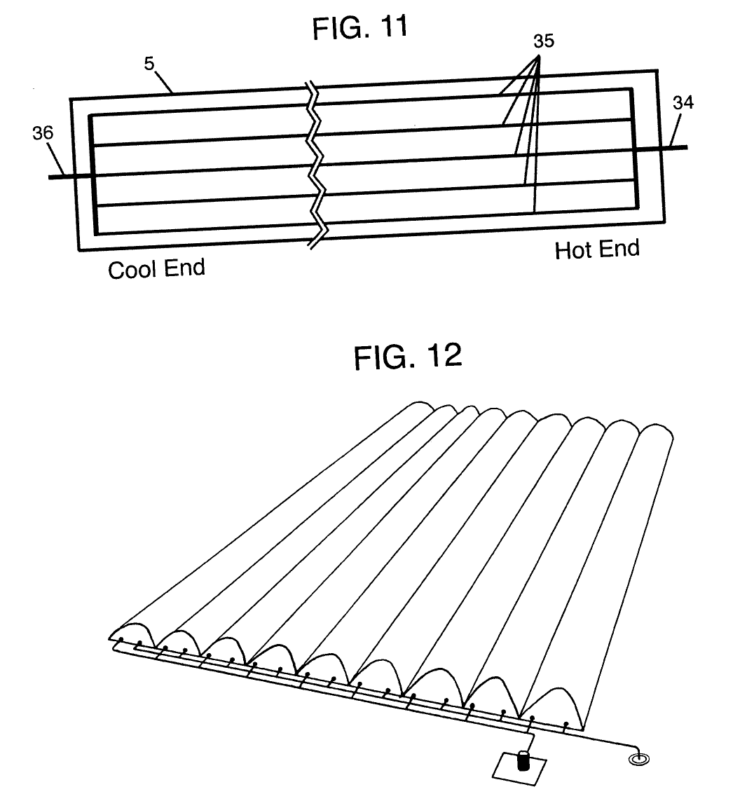

In the case where an outside hot water source is used to supplement heat received from solar insolation the incoming hot water coming for example from the output of a power plant cooling system would enter through inlet pipe 34 into the lower air duct of the ASC still at the still's hot end; see the top view shown in FIG. 11. This pipe would connect to one or more heat exchange pipes 35 lying along the floor of the still 5 and aligned approximately parallel to the long dimension of the air duct. As the water flows toward the cool end of the still, it progressively drops in temperature as it gives up its heat to the surrounding layer of feedstock water covering the floor of the still. At the cool end of the still, these heat exchange pipes would connect to outlet pipe 36 which would conduct the water out of the still and back to the power plant where it would be reused as cooling water. These heat exchange pipes may be made of corrosion resistant metal such as 90:10 Cu/Ni alloy or plastic coated aluminum pipe.

As illustrated in FIG. 12, many elongated ASC still bays may be placed side by side to form a rectangular solar still farm module. By positioning several such modules end to end so that the hot ends of one group of still bays are situated near the cool ends of the adjoining group of still bays, the evaporator and condenser heat exchangers of adjacent bays may be brought into close proximity with one another to facilitate power generation.

In a more portable version of the ASC still, light absorbing layer 5 may be fabricated from a heat sealable plastic film, in which case this film could be secured to plastic films 10 and 11 of plastic tube 9 and to the overlying insulating film 18 by heat sealing the edges of these films together along their perimeter, to be joined as shown in FIG. 10. The junction between layer 5 and layer 10 could be secured by means of a ziplock seal along part of this perimeter to allow the still's basin to be opened periodically for cleaning. In this portable version, fan 8 would more appropriately be mounted in first opening 12, as shown in FIG. 8. To reduce heat loss, the floor of the still could be laid upon a thin, lightweight layer of insulation such as ¼ inch thick Nanogel® panels. For remote locations where electricity is unavailable, the still's fan and water pumps could be powered by a small photovoltaic panel and associated rechargeable battery.

In addition to being designed to lie flat along the ground, the ASC still bays may also be designed to be inclined or oriented vertically along the wall of a building. The hot end of the still would be at the highest elevation and cool end of the still at the lowest elevation. In this way, the chimney effect would aid transport of the air up the evaporator chamber and then down the condensing chamber. The feedwater to be distilled would be pumped through a pipe from the bottom to the top of the still and at intervals sprayed onto a fluid-absorbing, light-absorbing wick surface and allowed to slowly drip downward. This wick could be made of black plastic fiber carpeting material or fabric.

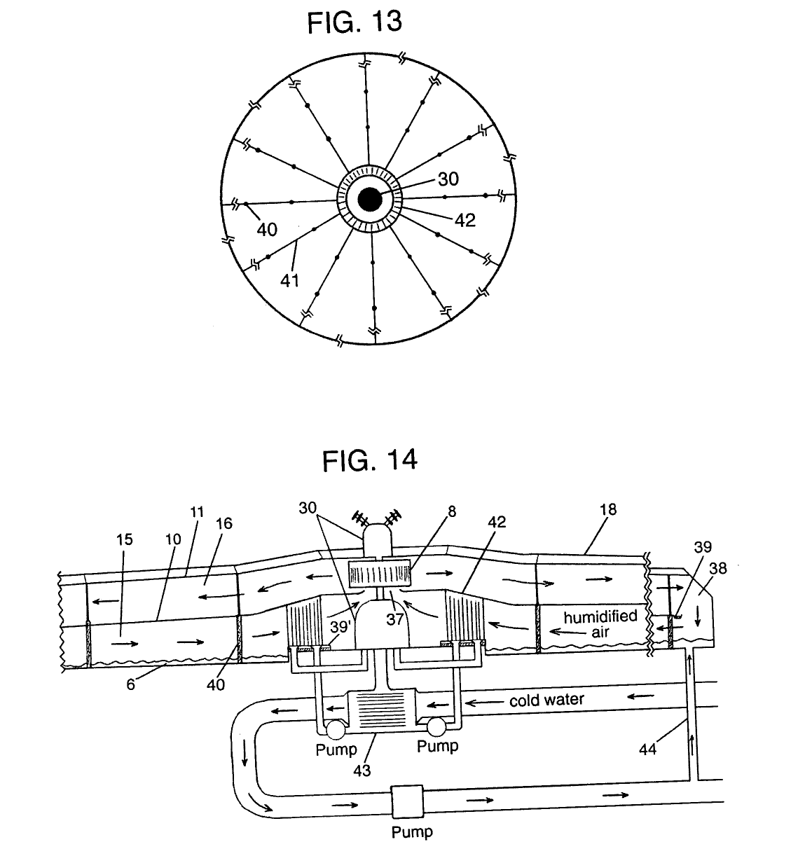

In another embodiment of the disclosed invention, the ASC still may be designed to have a circular, rather than an elongated rectangle footprint geometry. Referring to FIG. 13 and FIG. 14, a circular basin having a light-absorbing floor 5 is filled with a layer of feedstock water 6 to a depth of one or two inches. The basin is covered by light-transmitting plastic film roof layers 11 and 18 which are attached at their peripheries to floor 5 and which together with floor 5 form an enclosure. Roof layers 11 and 18 are spaced approximately 2 inches from one another by an intervening inflatable air layer to reduce heat loss through the roof of the still. An intermediate light-transmitting layer 10 is situated between light absorbing floor 5 and light-transmitting layer 11, dividing the still's interior air space into lower 15 and upper 16 air spaces or air ducts. A high-volume blower 8 draws heated and humidified air from the lower evaporator air duct causing air to flow radially inward from the cool periphery of the still to its hot center. Said air is warmed and humidified as it passes over the surface of the shallow solar heated pond of feedstock water. The air then passes through first opening 37 into blower 8 which exhausts this air into the upper air duct where water condensation occurs as the air passes from the hot center to the cooler periphery of the still. Upon reaching the still's periphery, the airstream reenters the lower air duct through second opening 38, a connecting edge air passage that extends around the periphery of the still, the width of this passage being comparable to the height of the upper or lower air duct. By designing the still so that light-transmitting layer 10 slopes from the center of the still downward toward the periphery of the still, condensate may be induced to run off into a collection trough 39 girdling the periphery of light-transmitting layer 10. As in the elongated ASC solar still embodiment, concentrated brine would be periodically removed from the basin at the cool end of the still to prevent salt build up.

The light-transmitting plastic film layers 10, and 11, are supported at periodic intervals by a series of poles 40 and cables 41 designed to keep the films erect against the positive pressure created in the upper air duct and negative pressure created in the lower air duct. These poles would be of sufficient length to space this layer from the feedstock water basin so as to allow a sufficient space for air flow. Alternatively, layer 11 may be supported by the positive pressure developed in the upper air duct when the blower is operating provided that an air vent communicates between the space behind the blower intake and the outside air to allow pressure equalization.

Alternatively, the still may be designed so that blower 8 instead blows air through the lower air duct from the center to the periphery of the still, the air then passing into the upper air duct through second opening 38 and then flowing from the periphery to the center of the still where it again passes through first opening 37 into blower 8. In this case, the cooler end of the air path would be at the still's center, where the blower is located, the periphery of the still now being the warmer extremity.

In the case where an ASC still of circular configuration is designed to use an external source of hot water to supplement solar heat captured through the still's roof, hot water would be conduct ed to the hot end of the still and allowed to pass through heat exchange pipes to the cool end of the still where the water would exit. In the situation where this external hot water source is cooling water conveyed from the heat exchanger of a remote power plant, this cool exit water may be returned to the power plant heat exchanger for reuse, thus flowing in a closed-loop. As in the tubular ASC still described earlier, the heat exchange pipes would lie along the floor of the still and would be immersed in a layer of feedstock water, thereby allowing the water's heat to be transferred to the surrounding water. In this circular configuration, the pipes would be arranged radially with respect to the center of the still. In the case where air in the lower air duct blows toward the center of the still, making the center of the still hot and the periphery cool, this external source of hot water would enter the still near its center and flow toward the still's periphery where it would exit. In the case where air in the lower air duct is advected toward the periphery of the still, making the periphery of the still hot and the center cool, this external source of hot water would enter the still near its periphery and flow toward the still's center where it would exit.

The circular version of the ASC solar still may be designed so that it is able to extract energy from its internally created temperature gradient. In the configuration where blower 8 pulls air inward through the lower evaporator air duct, the power plant's evaporator heat exchanger coil 42 would be centrally situated in a ring around the central blower. As the air passes through this coil a portion of its water vapor would condense and be gathered in an underlying fresh water collection trough 39′ for removal. The power plant condenser heat exchanger 43 could be located outside of the still and be cooled by pumping cooling water from a nearby water source. A portion of the cooling water outflow would be diverted to the floor of the solar still via pipe 44 to supply preheated feedstock water to the floor of the still. Condenser heat exchanger 43 may alternatively be situated within one of the still's air ducts at the cooler end of the still. The working fluid pressure difference generated between the evaporator and condenser heat exchangers could be made to drive a turbine-generator 30 located at the geometrical center of the still. If the air is instead made to flow outward through the lower evaporator air duct, evaporator heat exchanger 42 would instead be located at the periphery of the still and, if placed within the still, condenser heat exchanger 43 would instead be located near the center of the still which would now be the cooler extremity.

It should be understood that the foregoing disclosure emphasizes certain specific embodiments of the invention and that all modifications or alternatives equivalent thereto are within the spirit or scope of the invention as set forth in the appended claims.

What is claimed is:

1. A solar energy collecting assembly for distilling fluid comprising:
an elongated light-absorbing floor means for absorbing sunlight, said floor means being overlain by a layer of feedstock fluid,
an elongated light-transmitting roof means for allowing the transmission of sunlight, said roof means being situated above said floor means and fixedly attached at its perimeter to said floor means to form an enclosure,
an elongated light-transmitting air partition means, underlying said roof means and overlying said floor means, for partially dividing said enclosure into two tubular air ducts comprising an upper condenser air duct and a lower evaporator air duct, said air partition means being fixedly attached along its perimeter to said roof means and having a first opening near one of its extremities and a second opening near its opposite extremity to allow the free flow of air between said upper and lower air ducts,
a circulating means for circulating air within said enclosure so as to cause said air to enter said lower evaporator air duct through said first opening, to flow along the length of said lower evaporator air duct, to then pass through said second opening into said upper condenser air duct, to then flow along the length of said upper condenser air duct in a direction reverse to its flow direction in said lower evaporator air duct, and then to reenter said lower evaporator air duct by passing through said first opening, said circulating means propelling air with sufficient velocity so as to induce thermal gradients along the lengths of said upper and lower air ducts, said gradients having a temperature differential sufficient to induce the progressive evaporation of feedstock fluid along the length of said lower evaporator air duct and progressive condensation of the vapor of said fluid along the length of said upper condenser air duct to produce a fluid condensate, said thermal gradients having their hotter ends near said second opening and their cooler ends near said first opening.

2. The solar energy collecting assembly of claim 1 wherein said feedstock fluid is water.

3. The solar energy collecting assembly of claim 1 wherein control means are provided for regulating the speed of said circulating means.

4. The solar energy collecting assembly of claim 3 wherein said control means includes either; two or more temperature sensors for sensing the temperature differential along the length of said air ducts, a light-sensing means for sensing the ambient level of incident solar radiation, or a clock means for determining the time of day.

5. The solar energy collecting assembly of claim 1 wherein supply means are provided for conveying feedstock fluid from an external source to said floor means and wherein removal means are also provided for drawing said feedstock fluid from said floor means and conveying it out of said enclosure and wherein separate removal means are provided for conveying fluid condensate out of said upper condenser air duct.

6. The solar energy collecting assembly of claim 1 wherein spraying means are provided for spraying feedstock fluid into the air of said lower evaporator air duct.

7. The solar energy collecting assembly of claim 1 wherein said floor means are overlain by a solar-energy-absorbing wick means for assisting the humidifcation of air in said lower evaporator air duct.

8. The solar energy collecting assembly of claim 1 wherein said light-transmitting roof means comprises two or more elongated light-transmitting layers attached to one another at their periphery and wherein each of said layers is spaced apart from the other by an insulating air layer.

9. The solar energy collecting assembly of claim 1 wherein said light-transmitting roof means comprises two or more elongated light-transmitting film means attached to one another at their periphery and wherein each of said film means is spaced apart from the other by one or more insulating air layers, each of said insulating air layers being provided with an inflation means to admit outside air.

10. The solar energy collecting assembly of claim 1 wherein said light-transmitting air partition means comprises an elongated light-transmitting film means.

11. The solar energy collecting assembly of claim 1 wherein air vent means are provided to allow outside air to access said enclosure at a location near the air intake of said circulating means so as to permit said enclosure to inflate when said circulating means is operating.

12. The solar energy collecting assembly of claim 11 wherein forcing means are provided to force air through said air vent means into said enclosure.

13. The solar energy collecting assembly of claim 1 wherein the upper surface of said air partition means is hydrophobic and wherein the lower surfaces of said roof means and said air partition means are hydrophilic.

14. The solar energy collecting assembly of claim 1 wherein said floor means is underlain by insulating means for retarding the loss of heat.

15. The solar energy collecting assembly of claim 1 wherein said upper condenser air duct has a smaller cross sectional area at the end of said air duct near said second opening in said air partition means than at the end of said air duct near said first opening in said air partition means.

16. The solar energy collecting assembly of claim 1 wherein a heat exchange pipe means is provided which lies upon and extends along the length of said floor means for transferring heat to said layer of feedstock fluid, said heat exchange pipe means receiving hot fluid from an external heat source via an inlet pipe entering said enclosure at the end of said enclosure near said second opening in said air partition means and discharging cool fluid via an outlet pipe leaving said enclosure at the end of said enclosure near said first opening in said air partition means.

17. The solar energy collecting assembly of claim 1 wherein a first heat exchanger means is provided for condensing a working fluid and is positioned in one of said air ducts near said first opening in said air partition means, and wherein a second heat exchanger means is provided for evaporating said working fluid and is positioned in one of said air ducts near said second opening in said air partition means, the pressure differential induced in said working fluid between said heat exchangers being used to drive a turbine or heat engine means for performing useful work.

18. The solar energy collecting assembly of claim 1 wherein means are provided for positioning two or more of said assemblies adjacent to one another so that they share in common the same floor means.

19. The solar energy collecting assembly of claim 1 wherein said assembly is inclined and wherein pumping means are provided for pumping feedstock fluid from the lower elevation end to the higher elevation end of said lower evaporator air duct and for applying said fluid to the surface of a fluid-absorbing, solar energy absorbing wick layer covering the floor of said lower evaporator air duct.

20. An solar energy collecting assembly for distilling fluid comprising:
an elongated light-absorbing, thin film floor means for absorbing sunlight, said floor means being overlain by a layer of feedstock fluid,
an elongated light-transmitting, inflatable plastic film roof means for allowing the transmission of sunlight, said roof means being situated above said floor means and fixedly attached at its perimeter to said floor means to form an enclosure,
an elongated light-transmitting, inflatable plastic film air partition means, underlying said roof means and overlying said floor means, for partially dividing said enclosure into two tubular air ducts comprising an upper condenser air duct and a lower evaporator air duct, said air partition means being fixedly attached along its perimeter to said roof means and having a first opening near one of its extremities and a second opening near its opposite extremity to allow the free flow of air between said upper and lower air ducts,
a circulating means for circulating air within said enclosure so as to cause said air to enter said lower evaporator air duct through said first opening, to flow along the length of said lower evaporator air duct, to then pass through said second opening into said upper condenser air duct, to then flow along the length of said upper condenser air duct in a direction reverse to its flow direction in said lower evaporator air duct, and then to reenter said lower evaporator air duct by passing through said first opening, said circulating means propelling air with sufficient velocity so as to induce thermal gradients along the lengths of said upper and lower air ducts, said gradients having a temperature differential sufficient to induce the progressive evaporation of feedstock fluid along the length of said lower evaporator air duct and progressive condensation of the vapor of said fluid along the length of said upper condenser air duct to produce a fluid condensate, said thermal gradients having their hotter ends near said second opening and their cooler ends near said first opening,
an air vent means to allow outside air to access said enclosure at a location near the air intake of said circulating means so as to permit said enclosure to inflate when said circulating means is operating,
a supply means for conveying feedstock fluid from an external source to said floor means, a removal means for drawing said feedstock fluid from said floor means and conveying it out of said enclosure, and separate removal means for conveying fluid condensate out of said upper condenser air duct.

21. The solar energy collecting assembly of claim 20 wherein control means are provided for regulating the speed of said circulating means.

22. The solar energy collecting assembly of claim 20 wherein said floor means are overlain by a solar-energy-absorbing wick means for assisting the humidifcation of air in said lower evaporator air duct.

23. The solar energy collecting assembly of claim 20 wherein said light-transmitting roof means comprises two or more elongated light-transmitting film means attached to one another at their periphery and wherein each of said film means is spaced apart from the other by one or more insulating air layers, each of said insulating air layers being provided with an inflation means to admit outside air.

24. The solar energy collecting assembly of claim 20 wherein said floor means is underlain by insulating means for retarding the loss of heat.

25. The solar energy collecting assembly of claim 20 wherein said assembly is inclined and wherein pumping means are provided for pumping feedstock fluid from the lower elevation end to the higher elevation end of said lower evaporator air duct and for applying said fluid to the surface of a fluid-absorbing, solar energy absorbing wick layer covering the floor of said lower evaporator air duct.

26. A solar energy collecting assembly for distilling fluid comprising:
a light-absorbing floor means for absorbing sunlight, said floor means being overlain by a layer of feedstock fluid,
a light-transmitting roof means for allowing the transmission of sunlight, said roof means being situated above said floor means and fixedly attached at its perimeter to said floor means to form an enclosure,
a light-transmitting air partition means, underlying said roof means and overlying said floor means, for dividing said enclosure into an upper condenser air duct and a lower evaporator air duct, said air partition means being fixedly attached to said roof means along its perimeter and having two openings to allow the free flow of air between said upper and lower air ducts, one of said openings being situated near the geometrical center of said air partition means and the other of said openings being situated along the periphery of said air partition means,
a circulating means for circulating air within said enclosure so as to cause said air to enter said lower evaporator air duct through a first of said openings, to flow through said lower evaporator air duct, to then pass through the second of said openings into said upper condenser air duct, to then flow through said upper condenser air duct in a direction generally reverse to its flow direction in said lower evaporator air duct, and then to reenter said lower evaporator air duct by passing again through said first opening, said circulating means propelling air with sufficient velocity so as to induce thermal gradients along the direction of air flow through said upper and lower air ducts, said gradients having temperature differentials sufficient to induce the progressive evaporation of feedstock fluid along the direction of air flow through said lower evaporator air duct and the progressive condensation of the vapor of said fluid along the direction of air flow through said upper condenser air duct to produce a fluid condensate, said gradients having their hotter ends near said second opening and their cooler ends near said first opening.

27. The solar energy collecting assembly of claim 26 wherein said feedstock fluid is water.

28. The solar energy collecting assembly of claim 26 wherein control means are provided for regulating the speed of said circulating means.

29. The solar energy collecting assembly of claim 28 wherein said control means includes either:
two or more temperature sensors for sensing the temperature differential along the length of said air ducts, a light-sensing means for sensing the ambient level of incident solar radiation, or a clock means for determining the time of day.

30. The solar energy collecting assembly of claim 26 wherein supply means are provided for conveying feedstock fluid from an external source to said floor means and wherein removal means are also provided for drawing said feedstock fluid from said floor means and conveying it out of said enclosure and wherein separate removal means are provided for conveying fluid condensate out of said upper condenser air duct.

31. The solar energy collecting assembly of claim 26 wherein spraying means are provided for spraying feedstock fluid into the air of said lower evaporator air duct.

32. The solar energy collecting assembly of claim 26 wherein said floor means are overlain by a solar-energy-absorbing wick means for assisting the humidifcation of air in said lower evaporator air duct.

33. The solar energy collecting assembly of claim 26 wherein said light-transmitting roof means comprises two or more light-transmitting layers attached to one another at their periphery and wherein each of said layers is spaced apart from the other by an insulating air layer.

34. The solar energy collecting assembly of claim 26 wherein said light-transmitting roof means comprises two or more light-transmitting film means attached to one another at their periphery and wherein each of said film means is spaced apart from the other by one or more insulating air layers, each of said air layers being provided with an inflation means to admit outside air.

35. The solar energy collecting assembly of claim 26 wherein said light-transmitting air partition means comprises a light-transmitting film means.

36. The solar energy collecting assembly of claim 26 wherein support means are provided to support said light transmitting air partition means and said roof means to provide unrestricted air flow through said upper and lower air ducts.

37. The solar energy collecting assembly of claim 26 wherein air vent means are provided to allow outside air to access said enclosure at a location near the air intake of said circulating means so as to permit said enclosure to inflate when said circulating means is operating.

38. The solar energy collecting assembly of claim 26 wherein the upper surface of said air partition means is hydrophobic and wherein the lower surfaces of said roof means and said air partition means are hydrophilic.

39. The solar energy collecting assembly of claim 26 wherein said floor means is underlain by insulating means for retarding the loss of heat.

40. The solar energy collecting assembly of claim 26 wherein the cross sectional area of said upper condenser air duct is smaller near said second opening than it is near said first opening.

41. The solar energy collecting assembly of claim 26 wherein a heat exchange pipe means is provided which lies upon and extends along said floor means for transferring heat to said layer of feedstock fluid, said heat exchange pipe means receiving hot fluid from an external heat source via an inlet pipe entering said enclosure at a location near said second opening in said air partition means and discharging cool fluid via an outlet pipe leaving said enclosure at a location near said first opening in said air partition means.

42. The solar energy collecting assembly of claim 26 wherein a first heat exchanger means is provided for condensing a working fluid, said first heat exchanger means being positioned in one of said air ducts near said first opening in said air partition means, and wherein a second heat exchanger means is provided for evaporating said working fluid and which is positioned inside said enclosure near said second opening in said air partition means, the pressure differential induced in said working fluid between said heat exchangers being used to drive a turbine or heat engine means for performing useful work.

43. The solar energy collecting assembly of claim 42 wherein said second heat exchanger means is instead positioned outside said enclosure and is separately cooled by a flow of air or water.

44. A solar energy collecting assembly for distilling fluid comprising:
a light-absorbing floor means for absorbing sunlight, said floor means being overlain by a layer of feedstock fluid,
a light-transmitting roof means for allowing the transmission of sunlight, said roof means being situated above said floor means and being fixedly attached at its perimeter to said floor means to form an enclosure,
a light-transmitting air partition means, underlying said roof means and overlying said floor means, for dividing said enclosure into an upper condenser air duct and a lower evaporator air duct, said air partition means being fixedly attached to said roof means along its perimeter and having a communicating opening to allow the free flow of air between said upper and lower air ducts,
an inlet air passage means connecting with said lower evaporator air duct for admitting air to said enclosure and an outlet air passage means connecting with said upper condenser air duct for exhausting air from said enclosure, said air passage means both being located at an extremity of said enclosure that is distant from the location of said communicating opening,
a circulating means for circulating air within said enclosure so as to cause outside air to enter said lower evaporator air duct through said inlet air passage means, to flow along the length of said lower evaporator air duct, to then pass through said communicating opening into said upper condenser air duct, to then flow through said upper condenser air duct in a direction reverse to its flow direction in said lower evaporator air duct, and finally to exhaust from said upper condenser air duct by passing through said outlet air passage means, said circulating means propelling air with sufficient velocity so as to induce thermal gradients along the direction of air flow through said upper and lower air ducts, said gradients having temperature differentials sufficient to induce the progressive evaporation of feedstock fluid along the along the direction of air flow through said lower evaporator air duct and the progressive condensation of the vapor of said fluid along the direction of air flow through said upper condenser air duct to produce a fluid condensate, said gradients having their hotter ends near said communicating opening and their cooler ends near said air passage means.

45. The solar energy collecting assembly of claim 44 wherein said feedstock fluid is water.

46. The solar energy collecting assembly of claim 44 wherein control means are provided for regulating the speed of said circulating means.

47. The solar energy collecting assembly of claim 46 wherein said control means includes either:
two or more temperature sensors for sensing the temperature differential along the length of said air ducts, a light-sensing means for sensing the ambient level of incident solar radiation, or a clock means for determining the time of day.

48. The solar energy collecting assembly of claim 44 wherein supply means are provided for conveying feedstock fluid from an external source to said floor means and wherein removal means are also provided for drawing said feedstock fluid from said floor means and conveying it out of said enclosure and wherein separate removal means are provided for conveying fluid condensate out of said upper condenser air duct.

49. The solar energy collecting assembly of claim 44 wherein spraying means are provided for spraying feedstock fluid into the air of said lower evaporator air duct.

50. The solar energy collecting assembly of claim 44 wherein said floor means are overlain by a solar-energy-absorbing wick means for assisting the humidifcation of air in said lower evaporator air duct.

51. The solar energy collecting assembly of claim 44 wherein said light-transmitting roof means comprises two or more light-transmitting layers attached to one another at their periphery and wherein each of said layers is spaced apart from the other by an insulating air layer.

52. The solar energy collecting assembly of claim 44 wherein said light-transmitting roof means comprises two or more light-transmitting film means attached to one another at their periphery and wherein each of said film means is spaced apart from the other by one or more insulating air layers, each of said air layers being provided with an inflation means to admit outside air.

53. The solar energy collecting assembly of claim 44 wherein said light-transmitting air partition means comprises a light-transmitting film means.

54. The solar energy collecting assembly of claim 44 wherein support means are provided to support said light transmitting air partition means and said roof means to provide unrestricted air flow through said upper and lower air ducts.

55. The solar energy collecting assembly of claim 44 wherein the upper surface of said air partition means is hydrophobic and wherein the lower surfaces of said roof means and said air partition means are hydrophilic.

56. The solar energy collecting assembly of claim 44 wherein said floor means is underlain by insulating means for retarding the loss of heat.

57. The solar energy collecting assembly of claim 44 wherein the cross sectional area of said upper condenser air duct is smaller near said communicating opening than it is near said outlet air passage means.

58. The solar energy collecting assembly of claim 44 wherein a heat exchange pipe means is provided which lies upon and extends along said floor means for transferring heat to said layer of feedstock fluid, said heat exchange pipe means receiving hot fluid from an external heat source via an inlet pipe entering said enclosure at a location near said communicating opening in said air partition means and discharging cool fluid via an outlet pipe leaving said enclosure at a location near said air passage means.

59. The solar energy collecting assembly of claim 44 wherein a first heat exchanger means is provided for condensing a working fluid, said first heat exchanger means being positioned in said lower air duct near said inlet air passage means, and wherein a second heat exchanger means is provided for evaporating said working fluid, said second heat exchanger means being positioned in one of said air ducts near said communicating opening, the pressure differential induced in said working fluid between said heat exchangers being used to drive a turbine or heat engine means for performing useful work.
